(19) United States
(12) Patent Application Publication
(10) Pub. No.: US 2019/0340089 A1
(43) Pub. Date: Nov. 7, 2019

(54) METHOD AND APPARATUS TO PROVIDE UNINTERRUPTED OPERATION OF MISSION CRITICAL DISTRIBUTED IN-MEMORY APPLICATIONS

(71) Applicant: Intel Corporation, Santa Clara, CA (US)

(72) Inventors: Kshitij A. DOSHI, Tempe, AZ (US); Vadim SUKHOMLINOV, Santa Clara, CA (US); Francesc GUIM BERNAT, Barcelona (ES)

(21) Appl. No.: 16/513,478

(22) Filed: Jul. 16, 2019

(51) Int. Cl. G06F 11/20; G06F 1/28; G06F 1/30

(52) U.S. Cl. CPC G06F 11/2015; G06F 2201/85; G06F 1/30; G06F 1/28

(57) ABSTRACT

Data is mirrored in persistent memory in nodes in a computer cluster for redundancy. The data can be recovered from the persistent memory in a failed node by another node in the computer cluster through a low power network interface in the failed node.

### FIELD

This disclosure relates to in-memory computing and in particular to continuous availability of mission critical state stored in persistent memory in a node of a computer cluster.

### BACKGROUND

A computer cluster is a set of connected computers that work together and can be viewed as a single system. The nodes (servers) of a computer cluster (that can also be referred to as a data center) are typically connected through local area networks. Cloud hosting facilities can typically employ large data centers with a plurality of servers. In a system that uses in-memory computing, data is stored directly in a persistent system memory in each node (server) of the computer cluster. A persistent memory is a write-in-place byte addressable non-volatile memory. In-memory computing reduces latency by eliminating time spent moving data between a storage device and system memory in the node (server).

A mission critical system is a system that is essential to the survival of a business or organization. Distributed mission critical applications include Virtual Network Functions, Network boundary protection systems, Java®/Web commerce machines, Virtual Storage Area Networks (VSANs) and in-memory relational database management systems, for example SAP® HANA®.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a computer cluster that includes a plurality of nodes (for example, servers);

FIG. 2 is a block diagram of any one of the nodes shown in FIG. 1 that includes a low power network interface to allow data to be recovered from persistent memory by another node in the computer cluster when the node has failed, for example, due to a power-loss condition;

FIG. 3 is a block diagram illustrating a local stable store block in the persistent memory in the node shown in FIG. 2 that is accessible while power is provided to the system during a recovery operation;

FIG. 4A is a flowgraph illustrating operations performed in a node during normal operation;

FIG. 4B is a flowgraph illustrating operations in a node during remote take-over of the failed node by another node due to a power-failure in the failed node;

FIG. 4C is a flowgraph illustrating operations in a node during recovery of the failed node in an isolated mode;

FIG. 4D is a flowgraph illustrating operations in a node during restart and reintegration of the node in the cluster;

FIG. 5 is a block diagram of an embodiment of a server in a cloud computing system that includes a remote interface, remote recovery firmware and a PoE power adapter; and

FIG. 6 depicts an example of a data center that includes a plurality of nodes.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

Critical applications such as billing, charging, access protection, and regulatory compliance executing in a data center require quick failover when a node in the data center has a power failure. Each node of the computer cluster may store a portion of an in-memory relational database in a persistent memory. However, when a node with for example terabytes of memory is in a situation of power failure, its memory contents are not reachable from a remote peer node in the computer cluster. In an embodiment, data can be recovered from persistent memory in a node that has a power failure by a peer node through a low power network interface.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

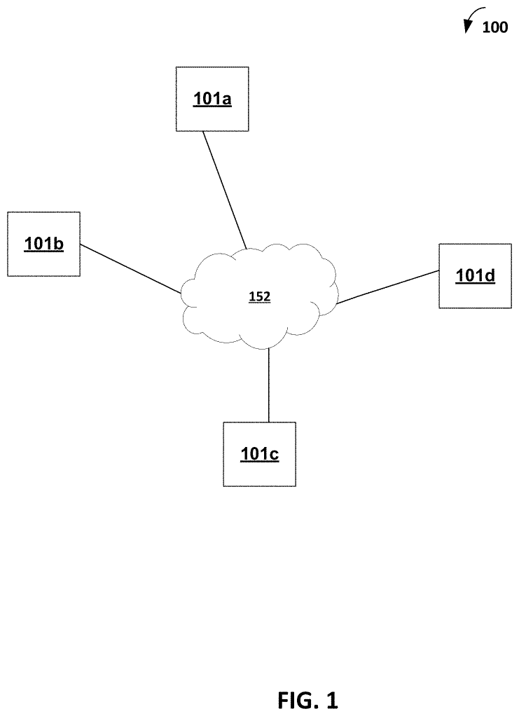

FIG. 1 is a block diagram of an embodiment of a computer cluster 100 that includes a plurality of nodes 101a-d (for example, servers). Each node 101a-d in the computer cluster 100 includes an interface to allow access through a low power network interface by at least one other node 101a-d in the computer cluster 100 to persistent memory in the node 101a-d. When a node fails, for example, node 100a fails due to power-loss, a peer node 101b-d in the computer cluster 100 can access data stored in the persistent memory in the failed node 101a through the low-power network interface.

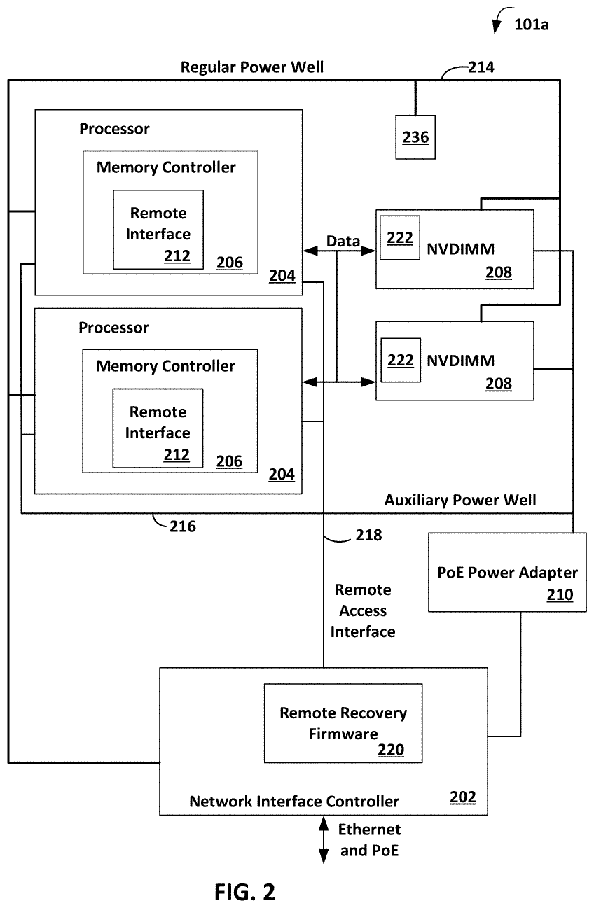

FIG. 2 is a block diagram of one node 101a in the computer cluster 100 shown in FIG. 1. Node 101a includes a low power network interface to allow data to be recovered from persistent memory in a failed node 100a-d by a peer node 101a-d in the computer cluster 100.

Referring to FIG. 2, node 101a includes a processor 204 with an integrated memory controller 206, persistent memory on a Non-Volatile memory Dual In-line Memory Module (NVDIMM) 208, a network interface controller (NIC) 202, a power supply 236 and a power adapter 210 (also referred to as a Power over Ethernet (PoE) power adapter). The integrated memory controller 206 includes a remote interface 212. In the embodiment shown, there are two processors 204 and two NVDIMMs 208.

The NVDIMM 208 includes persistent memory 222. In an embodiment, the persistent memory 222 is at least one persistent memory integrated circuit on the NVDIMM 208. In the embodiment shown in FIG. 2, the persistent memory 222 is on an NVDIMM 208. In other embodiments, the persistent memory 222 can be a persistent memory integrated circuit directly coupled to the integrated memory controller 206.

A Non-Volatile Memory (NVM) is a memory whose state is determinate even if power is interrupted to the device. A persistent memory is a byte-addressable write-in-place byte addressable non-volatile memory. The persistent memory has a Dynamic Random Address Memory (DRAM)-like access for write operations (write-in-place) in contrast to block-based memory for example, NAND. In an embodiment, the persistent memory 222 can comprise a byte-addressable write-in-place three dimensional cross point memory device, or other byte addressable write-in-place NVM device, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other persistent memory.

Node 101a includes a regular power well 214 that provides power from the power supply 236 to the processors 204, the NIC 202 and the NVDIMMs 208 during normal operation. While the node 101a is powered down and the power supply 236 is not supplying power, power can be provided via a backup or auxiliary power well 216 instead of via the regular power well 214. The backup or auxiliary power well 216 has approximately zero power draw during normal conditions while power is provided by the power supply 236 via the regular power well 214.

In an embodiment, auxiliary power is received by an Ethernet interface in the NIC 202 using the Power over Ethernet (PoE) standard (Institute of Electrical and Electronics Engineers (IEEE) 802.3af). The PoE standard includes a connect/disconnect protocol to apply and disconnect auxiliary power from node 101a. The connect/disconnect protocol detects if the node 101a needs auxiliary power, determines the amount of auxiliary power required and when to apply and remove auxiliary power. In another embodiment, auxiliary power can be provided via a Universal Serial Bus (USB) interface instead of via the Ethernet interface. For example, USB Power Delivery 2.0 Type-A/B/C USB is a power standard that can provide a maximum of 100 Watts of power.

The integrated memory controller 206 includes remote interface circuitry 212 retrains the memory interface to the NVDIMM 208 for low power operation. The remote interface circuitry 212 receives power from the auxiliary power well 216. The remote interface circuitry 212 in the integrated memory controller 206 is communicatively coupled to the NIC 202 via a remote access interface 218. While the auxiliary power is provided via the auxiliary power well 216 to the remote interface circuitry 212 in the integrated memory controller 206, the integrated memory controller 206 can extract critical information stored in persistent memory 222 in the NVDIMM 208. The extracted critical information can be transmitted through the NIC 202 to another node 101b-d in the computer cluster 100.

The NIC 202 includes a network port. The network port is used as an extraction point to access data stored in persistent memory 222 in the node 101a for a short interval of time after a loss of power from power supply 236. The NIC 202 includes remote recovery firmware 220 which is activated when there is a switch from the regular power well 214 to the auxiliary power well 216 to provide power for the node 101a. Remote recovery firmware 220 in the NIC 202 implements the necessary protocol (for example, Remote Direct Memory Access (RDMA)) to read (access) data stored in the persistent memory 222 in the NVDIMM 208, in response to a request received from at least one peer node.

The remote recovery firmware 220 in the NIC 202 includes the physical address(es) for the location of critical data that is stored in the persistent memory 222 in the NVDIMM 208. The stored critical data can include transaction logs, file system change journals, lists/arrays/bitmaps describing which pages or blocks in a memory range are allocated. In general, the critical data can include any information based on which it is possible for software to find or recover information that is only partially updated when normal execution gets interrupted due to a power failure condition.

The only memory related operation performed during low power operation (while power is applied via the auxiliary power well 216) is to read the critical data stored in the persistent memory 222 in the NVDIMM 208. The auxiliary power well provides power only for read operations because it is not necessary to provision additional power to perform other types of memory operations. The other types of memory operations can include a write operation, for example, to write data to the persistent memory 222 in the NVDIMM 208 or other memory operations, for example, to allocate memory, free memory or perform any other processor based operations within the node 101a while the critical data is being read from the persistent memory 222 in the NVDIMM 208.

If the memory content of the persistent memory 222 in the NVDIMM 208 is encrypted, the remote interface 212 in the integrated memory controller 206 performs authentication with node 101a (also referred to as a platform or a server) and potentially application specific cryptographic keys to obtain access to the encrypted memory content. Critical data is persisted into a portion of the persistent memory 222 that is allocated by firmware (that can be referred to as a critical region of the persistent memory) in the NVDIMM 208 at the time of loss of the regular power well 214 (for example, power provided by power supply 236). The critical data can be persisted by a power-fail persistent flush operation to write the critical data to the persistent memory 222 in the NVDIMM 208.

Typically, a cloud service provider employs backup batteries in the node 101a to provide power during transient failures in power distribution. These backup batteries can be used to provide power to the auxiliary power well 214. In an embodiment, power from the backup batteries can be provided in a parallel circuit to the power from main power supplies in the various nodes 101a-d. There can be power control switches between the batteries and the junction points where the battery circuit joins the power buses/wires from the power supplies. The power control switches can be used to prioritize which nodes 101a-d receive power when a transient power failure affects several nodes and a centralized scheduler (typically called an orchestrator, a rack manager, a pod manager, etc.) is making priority calls over which nodes 101a-d to keep activated and at what power level.

Some nodes 101a-d may be running critical data updates while other nodes 101a-d may be performing tasks that can be reinitiated later without risking data loss or corruption, and in that case, the power control switches may be used to direct power from the backup batteries to the first type of nodes and not to the second type of nodes. For example, if a node 101a-d is running an orchestrator, it itself is a priority node. Similarly, if a node is performing database transactions, it is a priority node because it must be given some grace period over which it can properly record results into a durable log from which the database tables can be later updated.

The Power over Ethernet (PoE) auxiliary power well 216 is only operational during recovery/failover, which is of limited duration. During normal system operation, the auxiliary power well 216 does not draw power and does not interfere with accesses to the persistent memory 222 in the NVDIMM 208.

A point of delivery (PoD) is a module of network, compute, storage, and application components that work together to deliver networking services. An orchestrator element (such as a PoD) manager) can track systems (for example, nodes 101a-d) in which critical services are running and prioritize these systems (for example, nodes 101a-d) for power continuity.

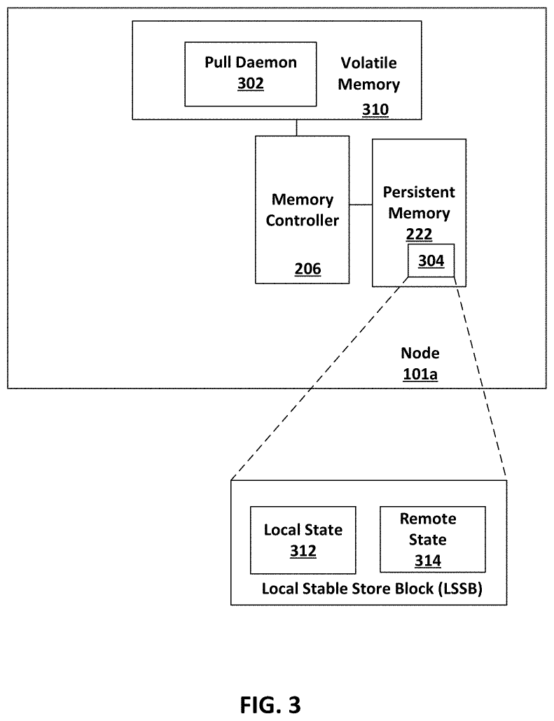

FIG. 3 is a block diagram illustrating the use of the critical region in node 101a shown in FIG. 2. The persistent memory 222 in NVDIMM 208 includes the critical region also referred to as a local stable store block 304 that is accessible while auxiliary power is provided to the auxiliary power well 214 in node 101a during a recovery operation after a power loss. During regular operation, replication of data and rendering of data logs and journals in the local stable control block 304 (also referred to as a critical region) in the persistent memory 222 in the NVDIMM 208 can be performed by ordinary but asynchronous operations because the local stable store block 304 (also referred to as critical region) is guaranteed to be reachable at any time. Thus, during normal operation, local operations are performed at cache speeds (nanoseconds) and not network speeds (microseconds).

The mission critical state stored in the local stable store block 304 is application dependent and can include re-playable data logs, journals, difference buffers, Log Structured Memory (LSM), metadata and/or re-playable operations logs. In addition to the non-volatile memory 206 that includes the local stable store block 304, the node 101a includes a memory controller 206 and a volatile memory 310.

The memory controller 206 can operate in one of three modes, local, isolated and remote. During normal operation, the memory controller 206 operates in local mode. The memory controller 206 operates in isolated mode for a short period of time following an operating system reboot due to loss of power. The memory controller 206 operates in remote mode just after a loss of power in the node 101a.

The Local Stable Store Block (LSSB) 304 is a portion of the persistent memory 222 that is used to store replicas or otherwise provide stable storage (that is, one or more copies of data is stored in one or more nodes) for updates made both in the local node 101a and in remote peer nodes 101b-d. Over time, new data is stored in the local stable store block 304 and older data is moved to other storage media (for example, a storage device such as a hard disk drive (HDD) or solid-state drive (SSD)).

The local stable store block 304 (also referred to as the critical region) includes a local state partition 312 and a remote state partition 314. The local state partition 312 stores the updates made in the local node 101a to the local state of a remote persistent memory 222 in a peer node 101b-d that is in a power-fail state. The remote state partition 314 stores select data (for example, log entries) received from a peer node 101b-d. The original select data is stored in another portion of the persistent memory 222. Critical data, for example, log entries received from a peer node and updates made in a peer node that can be accessed by another peer node includes the local state partition 312 and the remote state partition 314.

The node 101a includes a software daemon (for example, “pull daemon” 302) stored in volatile memory 310. A software daemon is a computer program that runs as a background process in the node 101a. During normal conditions while power is provided by the power supply 236 via the regular power well 214, the pull daemon 302 runs periodically and can be scheduled when necessary to retrieve (“pull”) data from a remote local stable store block in 304 in a remote node 101b-d and to store the retrieved data in a remote state partition 314 of the local stable store block 304.

The recovery operation (process) configures a port on a switch (not shown) to supply power for PoE. Remote recovery firmware 220 is activated on the NIC 202. The NVDIMM(s) 208 and memory controller(s) 206 are powered via the power adapter 210 which converts a voltage to a required voltage level for the auxiliary power well 216. The required voltage level can be determined by calibration and configuration. In an embodiment, the calibration and configuration is performed prior to the recovery operation and the required voltage level is stored in a table that is available as part of the critical data stored in the NVDIMM(s) 208.

The required voltage level for the node is dependent on the power requirements for components that are used for the recovery operation. A node 101a-d can include fans, NVDIMMs, volatile memory DIMMs, processors, storage devices (Solid State Drives, Hard Disk Drives), etc. In an embodiment, in a node that has a power failure, the auxiliary power can be used to provide power to one of a plurality of processors in the node, the other processors in the node are configured in a sleep state. Following a short burst of writes to flush all modified cache lines out of caches in the processors, the other processors can be pushed into lowest power sleep/suspended (Halted) states. Power for low speed read access is provided to the NVDIMM that is designated to store the critical data. Power is not provided to other components that are not required to be operational to read the critical data stored in the NVDIMM. For example, power is not provided to fans because passive cooling is sufficient and the overall thermal dissipation can be managed passively without keeping fans running.

The remote recovery firmware 220 includes instructions to perform memory interface retraining (for example, Row Address Strobe (RAS)-Column Address Strobe (CAS) for a persistent memory that has a JEDEC (Joint Electronic Device Engineering Council) DDR (Double Data Rate) memory interface) of the memory controller(s) 206 to operate with reduced power supplied by the power adapter 210.

The NIC Remote Recovery firmware 220 discovers the memory controller(s) 206 and serves as a proxy/transport to authenticate with the discovered memory controller(s) 206. The NIC Remote Recovery firmware 220 provides application specific authentication keys to access protected areas of the persistent memory 222 in the NVDIMM(s) 208.

An authentication process (for example, Intel® Multi-Key Total Memory Encryption (MKTME)) can be used to obtain a Universally Unique IDentifier (UUID) and a Public Key for remote recovery. A UUID is a 128-bit number that is used to identify information in a computer system. In this case, the Remote Interface 212 in the Memory Controller 206 requires credentials to access encrypted memory portions of persistent memory 222 in the NVDIMM(s) 208. The public key can be provisioned for a particular application domain. The public key and UUID can be stored in a portion (partition) of the NVDIMM 208 that is at a known address that is configured in the memory controller 206.

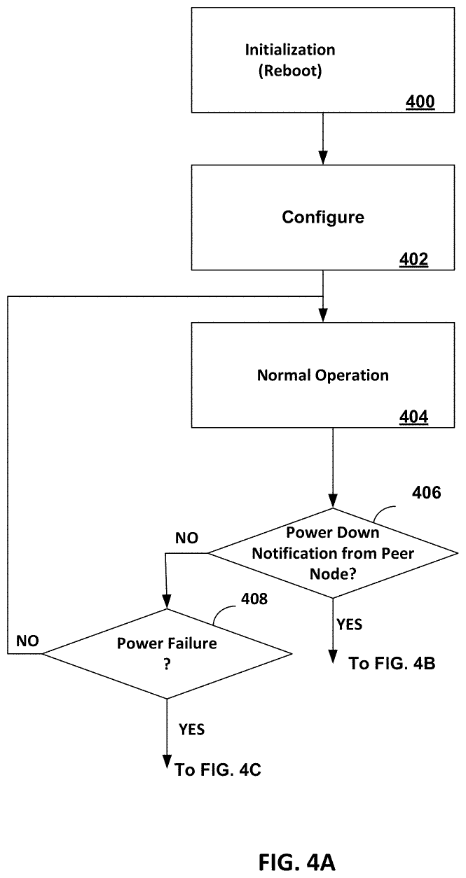

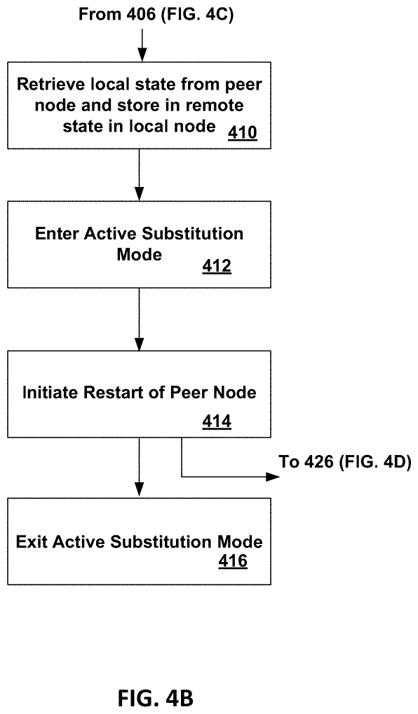

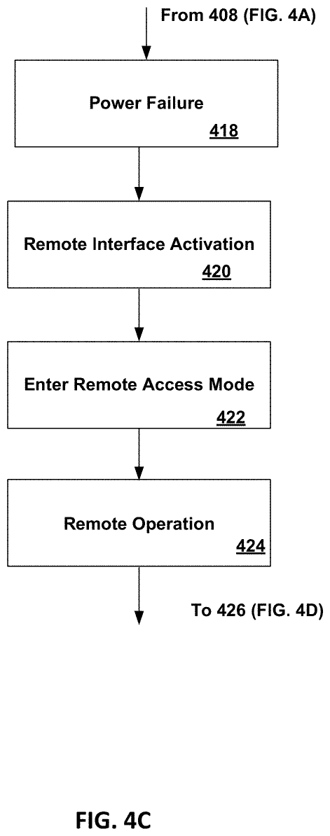

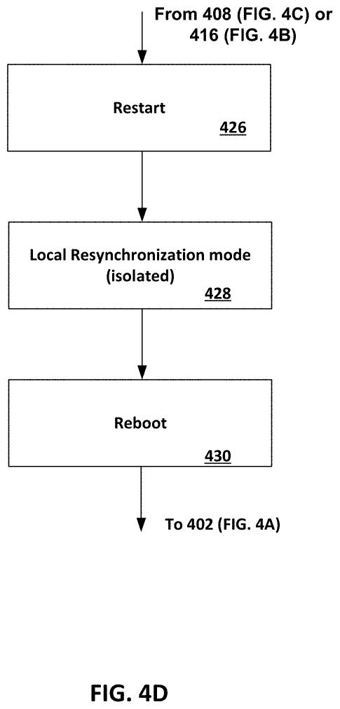

FIGS. 4A-4D describe operations performed in any of nodes 101a-d shown in FIG. 1. FIG. 4A is a flowgraph illustrating operations performed in node 101a-d during normal operation. FIG. 4B is a flowgraph illustrating operations in a node 101a-d during remote take-over of a failed node 101a-d by another node 101a-d due to a power-failure in the failed node 101a-d. FIG. 4C is a flowgraph illustrating operations in a node 101a-d during recovery of the failed node in an isolated mode. FIG. 4D is a flowgraph illustrating operations in a node 101a-d during restart and reintegration of the node 101a-d in the cluster. An example of failover in cluster 100 will be described for node 101a and a remote peer node 101b.

Turning to FIG. 4A, at block 400, node 101a is initialized to a known state after power has been applied to the node 101a or during a reboot operation in node 101a.

At block 402, the memory controller 206 in node 101a is configured for normal operation to access persistent memory 222 in NVDIMM 208.

At block 404, during normal operation, the node 101a executes applications. While executing applications, node 101a asynchronously updates replicated data (for example, a copy of data sent from peer node(s) stored in remote state 314) and local state 312 (“critical state”) stored in non-volatile memory 308 over the network in one or more other nodes (a remote peer) 101b-d. This limits the amount of data and state to be reconciled during a power-fail takeover of node 101b by node 101a or a power-fail takeover of node 101a by node 101b in the cluster 100.

At block 406, if node 101a receives a notification that remote peer node 101b is experiencing a power-down condition, node 101a enters a takeover mode while simultaneously continuing normal operation and processing continues with block 410 (FIG. 4B). If not, processing continues with block 408.

At block 408, if there is a power failure in node 101a, processing continues with block 418 (FIG. 4C). If not, processing continues with block 404 and node 101a continues normal operation.

Turning to FIG. 4B, at block 410, node 101a is in takeover mode for failed node (remote peer) 101b. In an embodiment, a pull daemon 302 in volatile memory 310 in node 101a replicates in node 101a the local state 312 that is stored in node 101b. Node 101a retrieves the local state 312 stored in the local stable store block 304 in non-volatile memory 308 in failed node 101b. The retrieved local state 312 from failed node 101b is stored in remote state 314 in the local stable store block 304 in non-volatile memory 308 in node 101a.

At block 412, node 101a begins to cover for the failed node 101b in active substitution mode. Node 101a takes over the operations for peer node(s) that node 101b was performing.

At block 414, after node 101a has stabilized coverage for the failed node 101b and reconciled any state updates into replicated data (data subject to stable store) in the Local Stable Store Block (LSSB) 304 from the failed node, restart of the failed node 101b can be initiated with a request to the failed node 101b to proceed with recovery. Restart is initiated via a restart request sent via the Network Interface Controller 102 in node 101a to node 101b. Node 101a continues substituting for (proxying) for node 101b until node 101b has returned to normal operation.

At block 416, active substitution mode is exited. Node 101b has recovered and no longer requires active substitution.

Turning to FIG. 4C, at block 418, in response to the power failure, node 101b performs an Asynchronous DRAM Refresh (ADR) to flush data buffers in volatile memory 310 to non-volatile memory and place the volatile memory 310 in a self-refresh mode. After the data buffers have been flushed, node 101b engages the PoE Power Adapter 110 by activating the PoE power wells.

At block 422, the memory controller 206 in node 101b is placed in remote mode by activating remote interface 112 in memory controller 106.

At block 424, node 101b enters remote access mode. Node 101b sends a signal to peer node 101a requesting active intervention and suspends normal operation. The power Adapter 210 is active and the memory controller 206 is in remote mode, allowing node 101a to retrieve data stored in non-volatile memory 308 in node 101b.

Turning to FIG. 4D, at block 426, node 101a has completed state extraction and activated restart for node 101b. Node 101b exits remote access mode and reboots into isolated mode.

At block 428, node 101b is in isolated mode (not a member of the cluster). While in isolated mode, node 101b completes local state and data reconciliation.

At block 430, node 101b reboots after completing recovery and processing continues with block 402 to configure the memory controller 206 in normal mode. Node 101b rejoins the cluster as a peer node to node 101a.

Power loss in a node 101a-d may be due to non-transient or transient conditions. A node can automatically recover from a power loss due to a transient condition. For example, a transient condition can be due to a high utilization of power in a data center during which the power supply in the data center cannot supply the required amount of amperage at the correct voltage, which requires abruptly shunting power temporarily to address the overload condition or correct it. The node resumes operation after the node recovers from the overload condition. Another example of transient condition is a drop in cooling efficiency in the server that can occur due to an increase in exterior temperature (for example, room temperature), which requires reducing power utilization in the data center by taking some portions of the data center offline.

A non-transient condition can be due to a failure of component in the node that that can require replacing or repairing the failed component. An example of a non-transient condition in a data server is a failure in a power supply.

Non-transient conditions (factors), which may include a power supply failure in a server, may arbitrarily prolong time to reboot and recover and reintegrate state changes for continuation of a distributed application operating on a plurality of nodes 101a-d in the computer cluster. Even transient failures may compromise availability if it takes a long time to restore a node 101a-d due to performing operations such as file system checks and data structure audits for structures in non-volatile memory. In an embodiment, a peer node can take over a failed node, complete any reconciliation of state, and operations can continue gracefully in the computer cluster after the failed node restarts.

In computing, the recovery operation described in conjunction with FIGS. 4A-D can be performed when a computer program such as a software application or an operating system stops functioning due to loss of power.

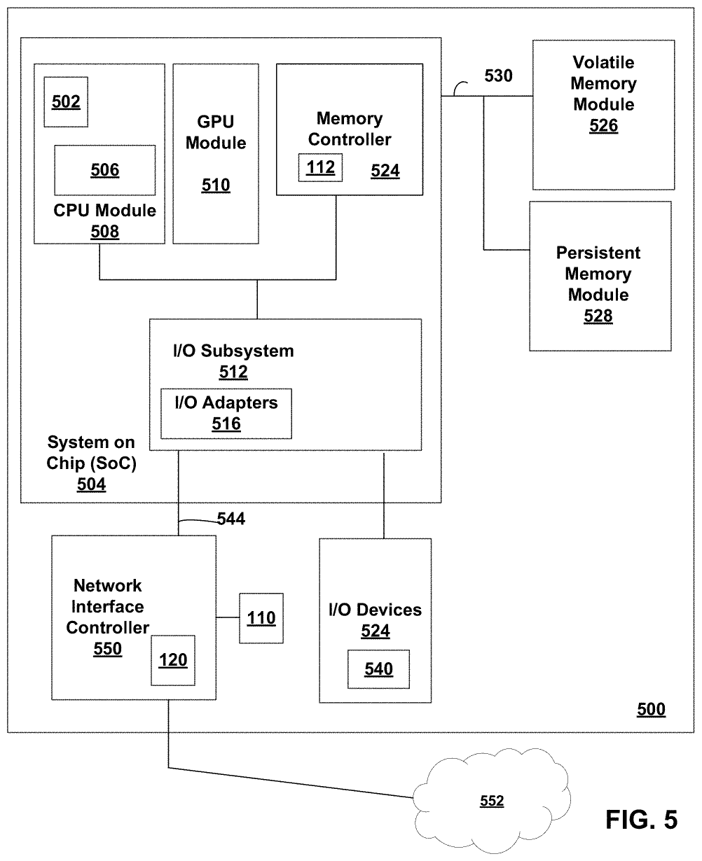

FIG. 5 is a block diagram of an embodiment of a server 500 in a cloud computing system that includes a remote interface 212, remote recovery firmware 120 and PoE power adapter 110. Server 500 includes a system on chip (SOC or SoC) 504 which combines processor, graphics, memory, and Input/Output (I/O) control logic into one SoC package. The I/O adapters 516 may include a Peripheral Component Interconnect Express (PCIe) adapter that is communicatively coupled over bus 544 to a network interface controller 550. The network interface controller 550 can include a compression engine to compress data received from network 552.

The SoC 504 includes at least one Central Processing Unit (CPU) module 508, a memory controller 514, and a Graphics Processor Unit (GPU) module 510. In other embodiments, the memory controller 514 may be external to the SoC 504. The CPU module 508 includes at least one processor core 502 and a level 2 (L2) cache 506.

Although not shown, the processor core 502 may internally include one or more instruction/data caches (L1 cache), execution units, prefetch buffers, instruction queues, branch address calculation units, instruction decoders, floating point units, retirement units, etc. The CPU module 508 may correspond to a single core or a multi-core general purpose processor, such as those provided by Intel® Corporation, according to one embodiment. In an embodiment the SoC 504 may be a standalone CPU such as an Intel® Xeon® Scalable Processor (SP), an Intel® Xeon® data center (D) SoC, or a smart NIC accelerator card format.

The memory controller 514 may be coupled to a persistent memory module 528 having at least one persistent memory integrated circuit and a volatile memory module 526 having at least one volatile memory integrated circuit via a memory bus 530. A non-volatile memory (NVM) device (integrated circuit) is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Volatile memory is memory whose state (and therefore the data stored in it) is indeterminate if power is interrupted to the device. Dynamic volatile memory requires refreshing the data stored in the device to maintain state. One example of dynamic volatile memory (device or integrated circuit) includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

The Graphics Processor Unit (GPU) module 510 may include one or more GPU cores and a GPU cache which may store graphics related data for the GPU core. The GPU core may internally include one or more execution units and one or more instruction and data caches. Additionally, the Graphics Processor Unit (GPU) module 510 may contain other graphics logic units that are not shown in FIG. 1, such as one or more vertex processing units, rasterization units, media processing units, and codecs.

Within the I/O subsystem 512, one or more I/O adapter(s) 516 are present to translate a host communication protocol utilized within the processor core(s) 502 to a protocol compatible with particular I/O devices. Some of the protocols that I/O adapter(s) 516 may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 516 may communicate with external I/O devices 524 which may include, for example, user interface device(s) including a display and/or a touch-screen display 540, printer, keypad, keyboard, communication logic, wired and/or wireless, storage device(s) including hard disk drives (“HDD”), solid-state drives (“SSD”) 518, removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

It is envisioned that aspects of the embodiments herein can be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities can typically employ large data centers with a multitude of servers. Each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board. These components can include the components discussed earlier in conjunction with FIG. 5.

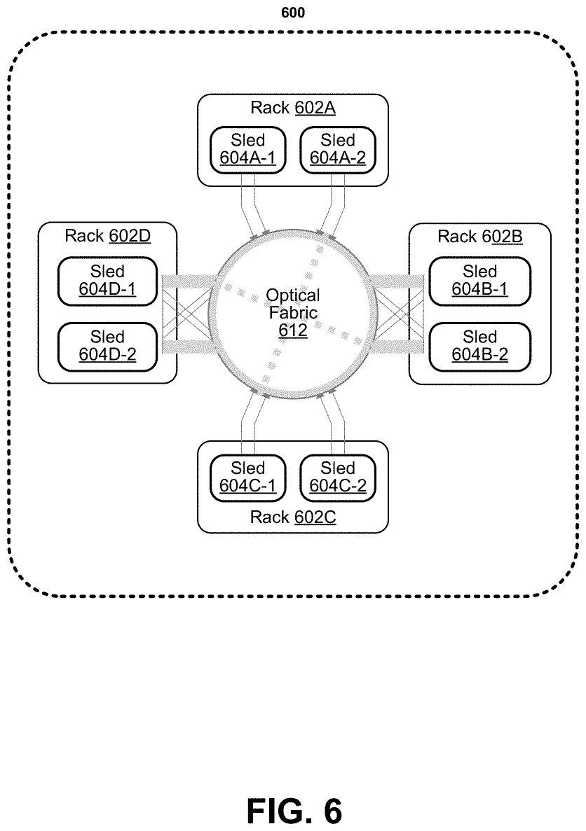

FIG. 6 depicts an example of a data center 600. Various embodiments can be used in or with the data center of FIG. 6. As shown in FIG. 6, data center 600 may include an optical fabric 612. Optical fabric 612 may generally include a combination of optical signaling media (such as optical cabling) and optical switching infrastructure via which any particular sled in data center 600 can send signals to (and receive signals from) the other sleds in data center 600. The signaling connectivity that optical fabric 612 provides to any given sled may include connectivity both to other sleds in a same rack and sleds in other racks. Data center 600 includes four racks 602A to 602D and racks 602A to 602D house respective pairs of sleds 604A-1 and 604A-2, 604B-1 and 604B-2, 604C-1 and 604C-2, and 604D-1 and 604D-2. Thus, in this example, data center 600 includes a total of eight sleds. Optical fabric 612 can provide sled signaling connectivity with one or more of the seven other sleds. For example, via optical fabric 612, sled 604A-1 in rack 602A may possess signaling connectivity with sled 604A-2 in rack 602A, as well as the six other sleds 604B-1, 604B-2, 604C-1, 604C-2, 604D-1, and 604D-2 that are distributed among the other racks 602B, 602C, and 602D of data center 600. The embodiments are not limited to this example. For example, optical fabric 612 can provide optical and/or electrical signaling.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
a persistent memory to store critical data;
a memory controller communicatively coupled to the persistent memory to read the critical data stored in the persistent memory;
a power supply to provide power to the persistent memory and the memory controller; and
a power adapter to provide auxiliary power to the persistent memory and the memory controller to process a request received from a node communicatively coupled to a network to read the critical data stored in the persistent memory while the power is not provided by the power supply.

2. The apparatus of claim 1, further comprising a network interface communicatively coupled to the memory controller and the network, the power adapter to provide auxiliary power to the network interface, the network interface to forward the request to read the critical data to the memory controller and to return the critical data read from the persistent memory to the node.

3. The apparatus of claim 1, wherein the persistent memory is a byte-addressable write-in-place three dimensional cross point memory device.

4. The apparatus of claim 1, wherein the critical data includes a local state of a remote persistent memory in another node that is in a power-fail state.

5. The apparatus of claim 1, wherein the critical data includes updates made in a remote peer node.

6. The apparatus of claim 1, wherein the memory controller includes a remote interface to retrain a memory interface to the persistent memory for low power operation to read the critical data in the persistent memory.

7. The apparatus of claim 1, wherein the apparatus is a server in a cloud computing system.

8. The apparatus of claim 1, wherein the apparatus is a sled in a data center.

9. A method comprising:
storing critical data in a persistent memory;
providing, by a power adapter coupled to a network interface, auxiliary power to the persistent memory, the network interface and a memory controller; and
processing, by the network interface, a request received from a node communicatively coupled to a network to the memory controller to read the critical data stored in the persistent memory while the auxiliary power is provided by the power adapter.

10. The method of claim 9, wherein the network interface to forward the request to read the critical data to the memory controller and to return the critical data read from the persistent memory to the node.

11. The method of claim 9, wherein the persistent memory is a byte-addressable write-in-place three dimensional cross point memory device.

12. The method of claim 9, wherein the critical data includes a local state of a remote persistent memory in another node that is in a power-fail state.

13. The method of claim 9, wherein the critical data includes updates made in a remote peer node.

14. The method of claim 9, wherein the memory controller includes a remote interface to retrain a memory interface to the persistent memory for low power operation.

15. A system comprising:
a memory module, the memory module comprising at least one volatile memory integrated circuit and a persistent memory to store critical data;
a memory controller communicatively coupled to the persistent memory to read the critical data stored in the persistent memory;
a network interface communicatively coupled to the memory controller and to a network;
a power supply to provide power to the persistent memory, the memory controller and the network interface; and
a power adapter coupled to the network interface, the power adapter to provide auxiliary power to the persistent memory, the network interface and the memory controller to allow the network interface to process a request received from a node communicatively coupled to the network to read the critical data stored in the persistent memory while the power is not provided by the power supply.

16. The system of claim 15, wherein the network interface to forward the request to read the critical data to the memory controller and to return the critical data read from the persistent memory to the node.

17. The system of claim 15, wherein the persistent memory is a byte-addressable write-in-place three dimensional cross point memory device.

18. The system of claim 15, wherein the critical data includes a local state of a remote persistent memory in another node that is in a power-fail state.

19. The system of claim 15, wherein the critical data includes updates made in a remote peer node.

20. The system of claim 15, wherein the memory controller includes a remote interface to retrain a memory interface to the persistent memory for low power operation.

21. The system of claim 15, wherein the node is a remote node.
